(19) United States
(12) Patent Application Publication
(10) Pub. No.: US 2025/0375054 A1
(43) Pub. Date: Dec. 11, 2025

(54) Chess Board Food Serving Tray

(71) Applicant: Rodney Manuel Jones, Glen Burnie, MD (US)

(72) Inventor: Rodney Manuel Jones, Glen Burnie, MD (US)

(21) Appl. No.: 19/229,748

(22) Filed: Jun. 5, 2025

Related U.S. Application Data
(60) Provisional application No. 63/656,494, filed on Jun. 5, 2024.

(51) Int. Cl. A47G 23/06; A23G 1/50; A23G 3/50; A63F 3/02

(52) U.S. Cl. CPC A47G 23/06; A63F 3/02; A23G 1/50; A23G 3/50

(57) ABSTRACT

A chess board food serving tray is a device that incorporates the features of a chess board on a food serving tray. The device can accommodate different food items that can be selectively consumed and/or used to play a game of chess on the device. The device includes a serving tray, a plurality of chess-piece-themed food items, and a plurality of chess-board-themed slots. The serving tray corresponds to a rectangular structure of the device large enough to retain the plurality of chess-piece-themed food items. The plurality of chess-board-themed slots is incorporated on the serving tray to retain at least one food item of the plurality of chess-piece-themed food items. The plurality of chess-piece-themed food items includes several pieces of food that can be used to play chess on the serving tray or for consumption.

The current application claims a priority to the U.S. provisional patent application Ser. No. 63/656,494 filed on Jun. 5, 2024.

### FIELD OF THE INVENTION

The present invention generally relates to serving trays and ornamental utility accessories. More specifically, the present invention discloses a food serving tray with an ornamental design that resembles a chess board.

### BACKGROUND OF THE INVENTION

Disposable single-use packaging presents significant environmental and economic challenges. One of the foremost issues is the sheer volume of waste generated; billions of single-use items such as plastic bags, bottles, and food containers are discarded annually, overwhelming landfills and littering natural landscapes. These materials, primarily plastics, are not biodegradable and can persist in the environment for hundreds of years, contributing to pollution in oceans, rivers, and urban areas. The production of single-use packaging is resource-intensive, relying heavily on fossil fuels, which contributes to greenhouse gas emissions and exacerbates climate change. Additionally, the breakdown of plastics leads to the release of microplastics, which infiltrate ecosystems and enter the food chain, posing health risks to wildlife and humans. The economic cost of managing this waste is substantial, burdening municipal waste management systems and taxpayers. Furthermore, single-use packaging often represents a linear economy model of production and disposal, as opposed to a circular economy that promotes sustainability through reuse and recycling.

Teaching children to play chess offers a multitude of cognitive, social, and emotional benefits that contribute to the children's overall development. One of the primary advantages is the enhancement of critical thinking and problem-solving skills; chess requires players to anticipate opponents' moves, strategize, and make decisions under pressure, which fosters analytical and strategic thinking. Chess also improves concentration and memory, as children must remember the positions of pieces and the consequences of various moves. Moreover, chess encourages patience and discipline, as success often requires long-term planning and the ability to delay gratification. Socially, chess can be a bridge to interaction, teaching children about sportsmanship, respect for others, and the importance of learning from both wins and losses. Emotionally, playing chess helps build resilience and self-confidence, as children learn to cope with setbacks and persist through challenges. Additionally, chess offers a constructive outlet for competition and can be a fun, engaging way for children to spend time, promoting mental agility and a love for lifelong learning.

Therefore, by providing a food serving tray that doubles as a chess board, the present invention can help reduce the effects of single use plastics while helping people learn and play chess to improve development and enjoyment in life.

### SUMMARY OF THE INVENTION

The present invention discloses a chess board food serving tray. The food serving tray of the present invention has an overall ornamental design that resembles a chess board. To do so, the food serving tray of the present invention includes 64 slots that hold the corresponding food items including, but not limited to, cheese, candy, chocolate, etc. The 64 slots are arranged to resemble the 64 squares of a chess board, including the same checkerboard pattern. The food serving tray of the present invention also includes several features that facilitate the retrieval and consumption of the retained food items. Further, the food items being retained in the food serving tray may also be designed to resemble the chess pieces. This way, the user can play chess using the food items on the food serving tray while consuming the food items. Additional features and benefits of the present invention are further discussed in the sections below.

### BRIEF DESCRIPTION OF THE DRAWINGS

FIG. 1 is a top-front-left perspective view of the present invention, wherein chess-piece-themed food items are shown placed on the chess-board-themed slots of the serving tray.

FIG. 2 is a bottom-rear-right perspective view of the present invention thereof.

FIG. 3 is a top view of the present invention thereof.

FIG. 4 is a top-front-left perspective view of the serving tray of the present invention.

FIG. 5 is a magnified view of a dark-themed slot of the chess-board-themed slots of the serving tray shown in FIG. 4.

FIG. 6 is a magnified view of a light-themed slot of the chess-board-themed slots of the serving tray shown in FIG. 4.

FIG. 7 is a top-front-left perspective view of a light-themed piece of the chess-piece-themed food items of the present invention.

FIG. 8 is a bottom-rear-right perspective view of the light-themed piece of the chess-piece-themed food items of the present invention.

FIG. 9 is a top-front-left perspective view of a dark-themed piece of the chess-piece-themed food items of the present invention.

FIG. 10 is a bottom-rear-right perspective view of the dark-themed piece of the chess-piece-themed food items of the present invention.

### DETAILED DESCRIPTION OF THE INVENTION

All illustrations of the drawings are for the purpose of describing selected versions of the present invention and are not intended to limit the scope of the present invention.

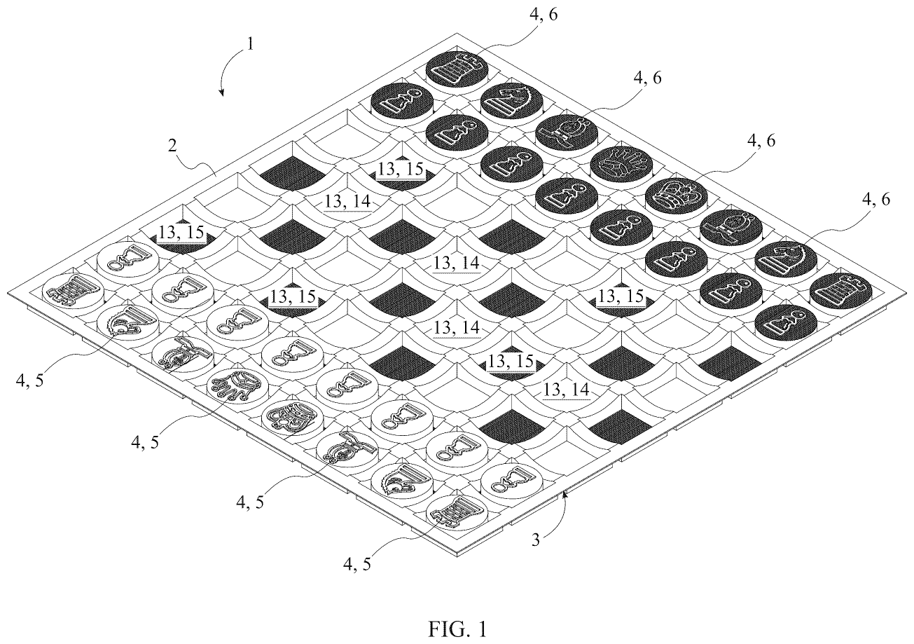

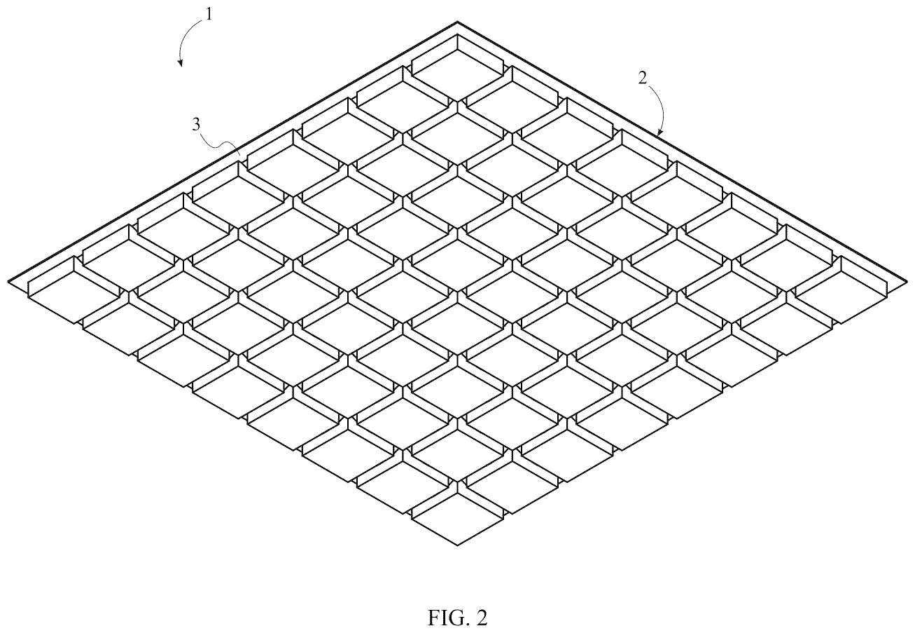

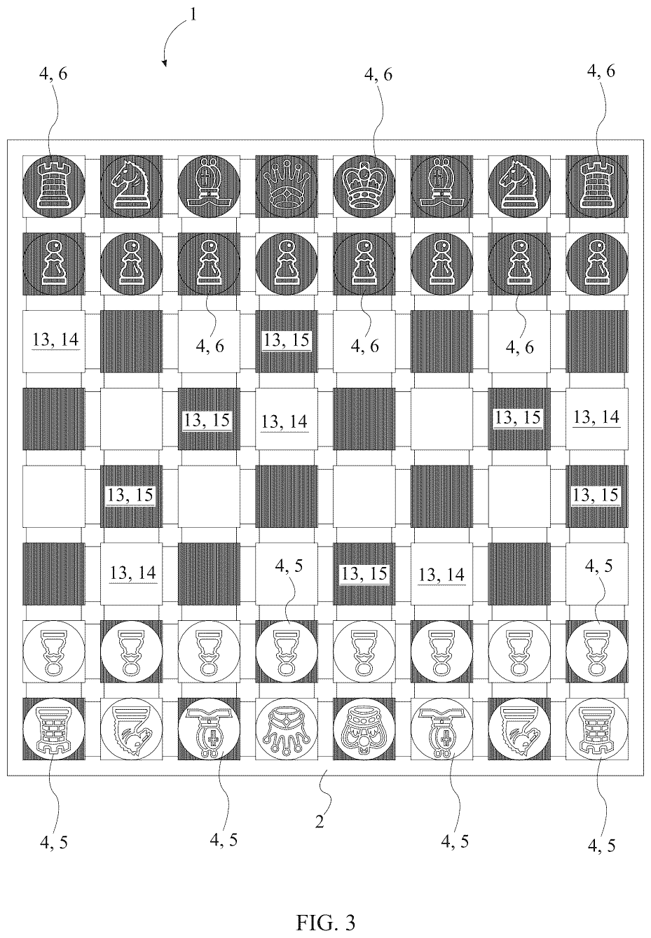

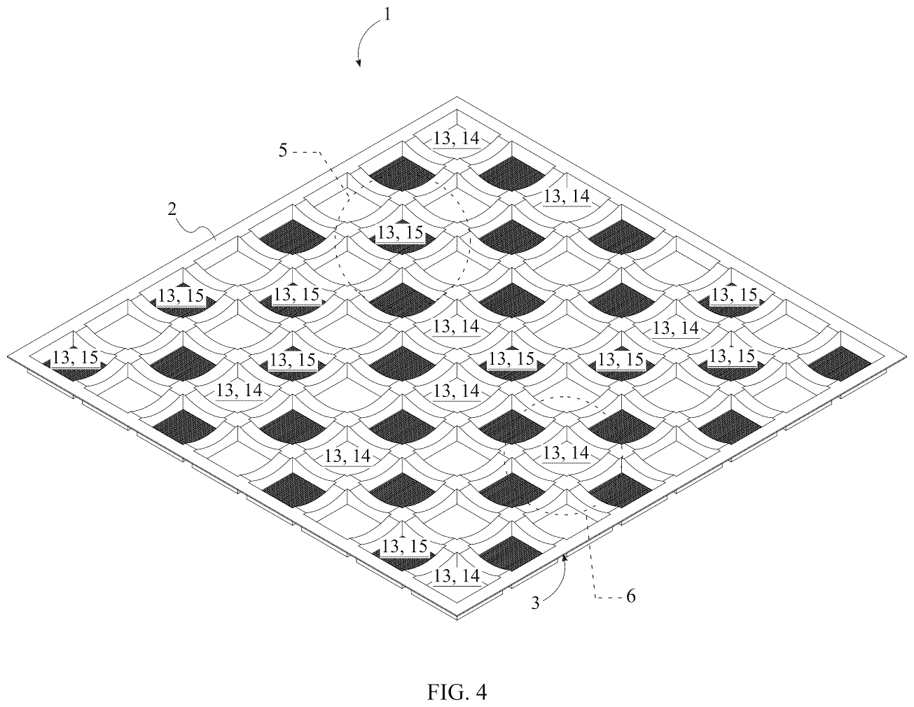

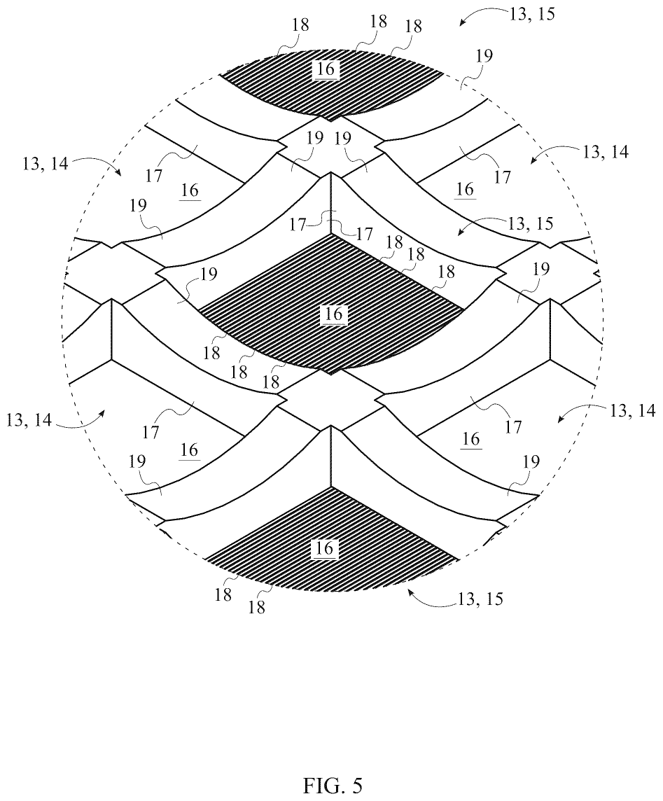

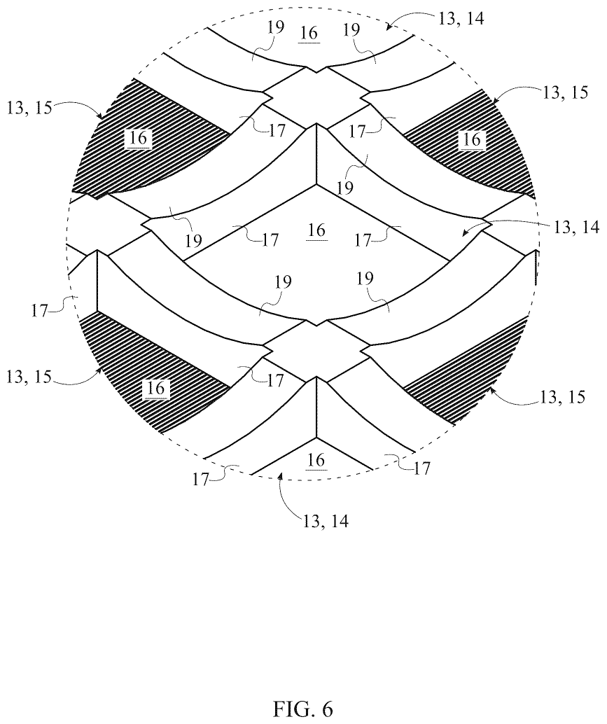

The present invention discloses a chess board food serving tray that incorporates the features of a chess board on a food serving tray. The present invention can accommodate different food items including, but not limited to, candy, chocolate, cheese, etc., which can be selectively consumed and/or used to play a game of chess. In the preferred embodiment, the present invention comprises a serving tray 1, a plurality of chess-piece-themed food items 4, and a plurality of chess-board-themed slots 13, as can be seen in FIGS. 1 through 6. The serving tray 1 corresponds to a rectangular structure large enough to retain the plurality of chess-piece-themed food items 4. The plurality of chess-board-themed slots 13 is incorporated on the serving tray 1 to retain at least one food item of the plurality of chess-piece-themed food items 4. The plurality of chess-piece-themed food items 4 includes several pieces of food that can be used to play chess on the serving tray 1 or for consumption.

The general configuration of the aforementioned components enables the user to consume the available food items while playing a game of chess. As can be seen in FIGS. 1 through 6, the serving tray 1 preferably has a flat square design, and the overall size of the serving tray 1 depends on the chess-piece-themed food items being retained by the serving tray 1. In general, the serving tray 1 comprises an upper tray face 2 and a lower tray face 3 corresponding to the opposite flat surfaces of the serving tray 1. In addition, the plurality of chess-board-themed slots 13 is designed to complement the checkerboard pattern design of the serving tray 1. So, the plurality of chess-board-themed slots 13 comprises a plurality of light-themed slots 14 and a plurality of dark-themed slots 15. Further, to complete the chess board design, the plurality of chess-piece-themed food items 4 also comprises a plurality of light-themed pieces 5 and a plurality of dark-themed pieces 6.

In general, the present invention can be arranged as follows: the plurality of chess-board-themed slots 13 is integrated into the serving tray 1 from the upper tray face 2 so that the plurality of chess-board-themed slots 13 is part of the serving tray 1, as can be seen in FIGS. 1 through 6. The plurality of chess-board-themed slots 13 is arranged into a grid configuration across the upper tray face 2 to match the design of a chess board. The plurality of chess-board-themed slots 13 is configured the same way as a traditional chess board with a square grid consisting of 64 chess-board-themed slots arranged in an 8×8 matrix. In addition, the plurality of dark-themed slots 15 and the plurality of light-themed slots 14 are interspersed amongst each other in a checkerboard pattern. In other words, the chess-board-themed slots alternate in color between the two contrasting shades. Furthermore, each of the plurality of chess-piece-themed food items 4 is positioned within a corresponding themed slot from the plurality of chess-board-themed slots 13. The chess-piece-themed food items are retained by the chess-board-themed slots in such a way that at least one food item is placed on each slot.

The serving tray 1 of the present invention may be constructed from different food-safe materials including, but not limited to, plastic, vinyl, or glass. The materials chosen can also include different properties, such as being dishwasher safe. The material chosen for the serving tray 1 can include Polyethylene terephthalate (PET), High-density polyethylene (HDPE), Low-density polyethylene (LDPE), Polypropylene (PP), Polystyrene (PS), and polyvinyl chloride (PVC).

For consumable and disposable embodiments of the serving tray 1, certain plastics are particularly well-suited due to the protective properties, flexibility, and ability to maintain product freshness. For example, PP is one of the best choices for candy and chocolate packaging since PP is clear, durable, and has a high melting point which makes the product resistant to heat and moisture. This ensures that the candies or chocolates stay fresh and protected from environmental factors.

PET is another excellent option, especially for packaging larger quantities or bulk items. PET is strong, lightweight, and provides a good barrier against gases and moisture, which helps in maintaining the freshness and flavor of candy and chocolates. PET is commonly used for clear containers or rigid packaging that allows the product to be seen while providing robust protection.

LDPE is also widely used for its flexibility and strength. LDPE is often employed in the form of bags or pouches for candy and chocolate pieces. LDPE provides a good barrier to moisture and is easy to seal, which helps in extending the shelf life of the products. Additionally, LDPE is resistant to punctures and tears, ensuring that the packaging remains intact during transportation and handling.

For premium chocolates, High-Barrier Films made from a combination of different plastics like PET, PP, and aluminum layers can be used. These films provide excellent protection against moisture, oxygen, and light, all of which can degrade the quality of chocolate. These high-barrier films ensure that the chocolates remain in optimal condition, retaining their taste, texture, and aroma.

Similar to a traditional chess board, the plurality of chess-board-themed slots 13 is oriented so that each player has a light-themed slot on the right-hand side at the closest row, as can be seen in FIGS. 1 through 6. The rows of the plurality of chess-board-themed slots 13, known as ranks, are numbered one to eight from the player's perspective, while the columns, called files, are labeled a to h from left to right. This alternating color pattern helps differentiate the chess-board-themed slots and guides the movement of the pieces. Each slot is identified by a unique coordinate combination of file and rank, such as al for the bottom-left corner slot and h8 for the top-right corner slot.

As previously discussed, the plurality of chess-board-themed slots 13 is designed with contrasting themes similar to how the squares on a chess board have contrasting colors, as can be seen in FIGS. 1 through 6. In some embodiments, the entire structure of each slot can be designed with the corresponding light or dark theme. For example, all the interior surfaces of each slot can be embellished with the corresponding theme using different methods including, but not limited to, coloring the interior surfaces, applying an ornamental layer to the interior surfaces, etc. Alternatively, portions of each slot can be designed to visually demonstrate the corresponding theme. For example, one or more interior surfaces of each slot can be adorned, the surfaces adjacent to the external edges of each slot can include a visual marker, etc.

In the preferred embodiment, the slot base 16 of each of the plurality of chess-board-themed slots 13 is embellished to visually indicate the corresponding theme, as can be seen in FIGS. 1 through 6. The slot base 16 corresponds to the base structure opposite the opening of the corresponding slot that supports the food item placed within the slot. For example, the slot base 16 for each of the plurality of light-themed slots 14 can be made a light color, while the slot base 16 for each of the plurality of dark-themed slots 15 can be made a dark color.

In another embodiment, physical methods can be utilized to visually indicate the theme of the corresponding slot on the slot base 16. For example, each of the plurality of dark-themed slots 15 may comprise a plurality of slot protruding ridges 18 arranged to give the corresponding slot base 16 a dark appearance, as can be seen in FIGS. 1 through 6. To do so, the plurality of slot protruding ridges 18 is mounted onto the slot base 16 to make the slot protruding ridges part of the slot base 16. In addition, the plurality of slot protruding ridges 18 is arranged in a stripe pattern across the slot base 16 so that each slot protruding ridge is parallel to each other. Further, the plurality of slot protruding ridges 18 is configured to visually generate the dark color on the corresponding slot base 16. For example, the plurality of slot protruding ridges 18 can be positioned at a short distance from each other to darken the corresponding slot base 16. In other embodiments, different physical features can be implemented to darken each slot base 16 of the plurality of dark-themed slots 15.

As previously discussed, the serving tray 1 can be configured to facilitate the consumption of the plurality of chess-piece-themed food items 4. In some embodiments, each of the plurality of chess-board-themed slots 13 may comprise a slot base 16, a plurality of lateral walls 17, and a plurality of finger-receiving cutouts 19, as can be seen in FIGS. 1 through 6. Each of the plurality of chess-board-themed slots 13 preferably has a rectangular design with the slot base 16 being a squared base and the plurality of lateral walls 17 including four lateral walls of equal size. Further, the plurality of finger-receiving cutouts 19 corresponds to several round recessions on the lateral walls that enable the user to retrieve the food item using two or more fingers.

As can be seen in FIGS. 1 through 6, to implement the plurality of finger-receiving cutouts 19, the plurality of lateral walls 17 is positioned around the slot base 16 due to the rectangular design of each slot. Further, each of the plurality of finger-receiving cutouts 19 is integrated into a corresponding lateral wall from the plurality of lateral walls 17, offset from the slot base 16, so that the finger-receiving cutouts are positioned adjacent to the upper tray face 2. For the center chess-board-themed slots of the plurality of chess-board-themed slots 13, four finger-receiving cutouts can be implemented on each side of the center slot. This allows the food item on each center slot to be able to be retrieved from any direction. On the other hand, the perimeter chess-board-themed slots of the plurality of chess-board-themed slots 13 have three finger-receiving cutouts positioned on the sides of the perimeter chess-board-themed slot that is not adjacent to the edges of the serving tray 1. This allows the food item on each perimeter chess-board-themed slot to be retrieved. In other embodiments, different mechanisms can be implemented to help the user consume the retained chess-piece-themed food items.

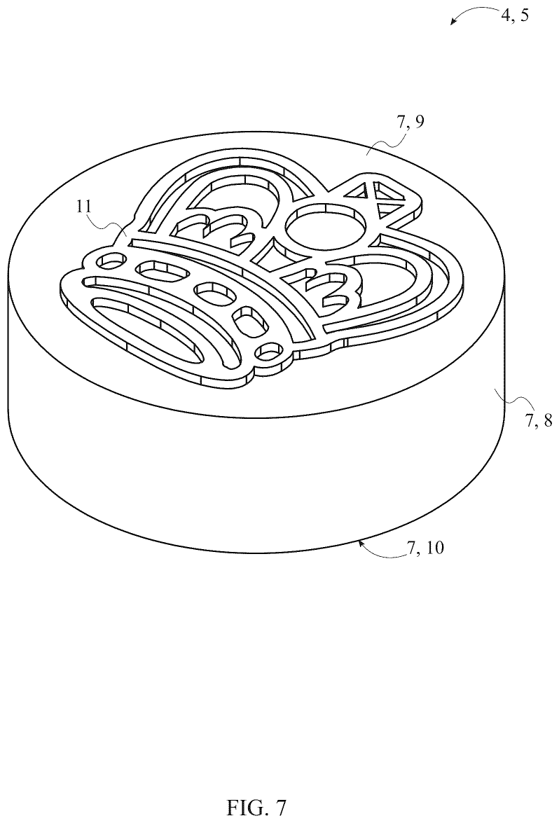

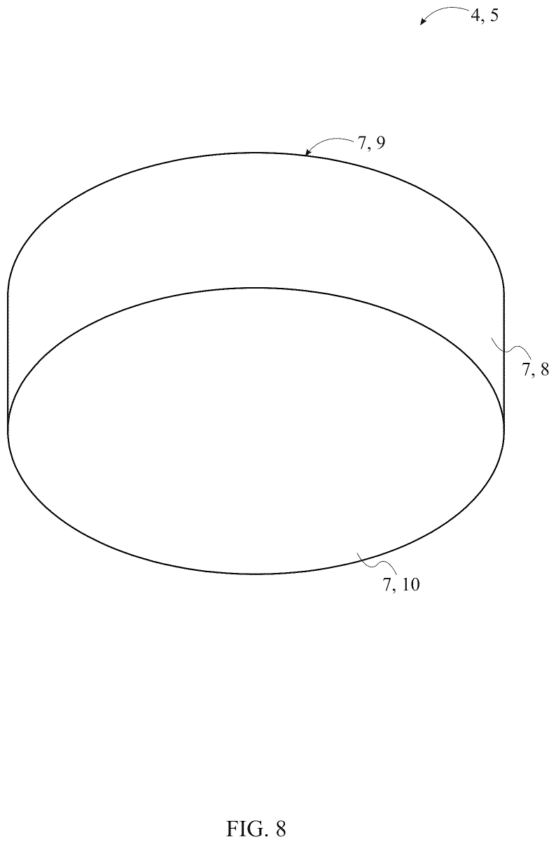

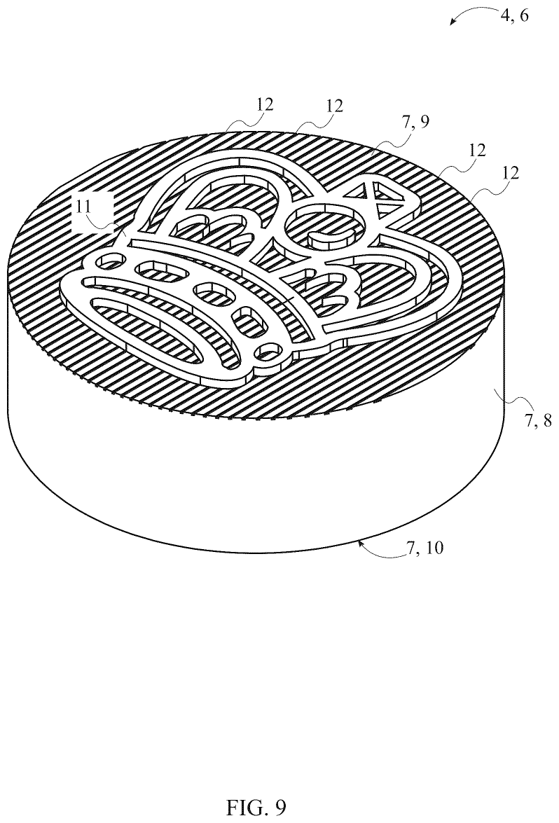

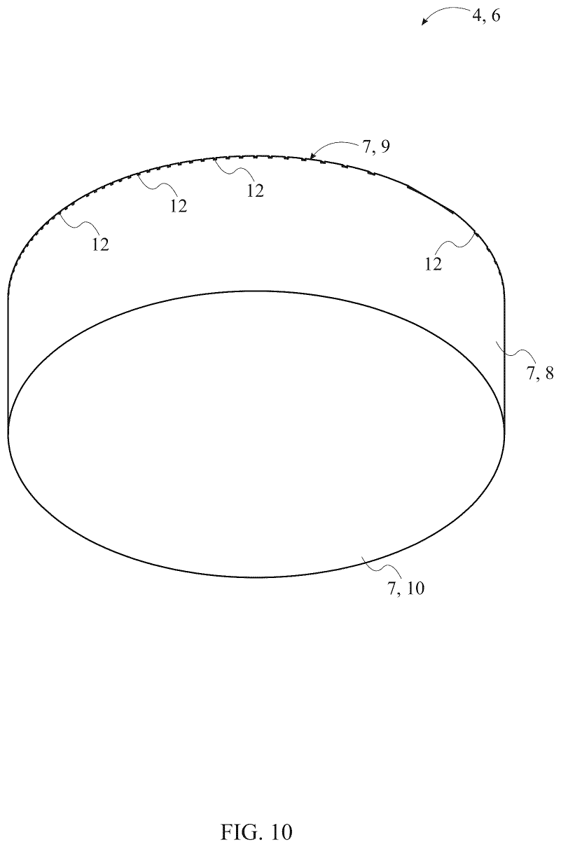

Generally, the serving tray 1 can be used to retain different types of food items, such as pieces of cheese, fruit, chocolate, candy, etc. However, the food items provided are preferably designed to resemble the chess pieces necessary to play a game of chess. As can be seen in FIGS. 7 through 10, to implement the chess piece design on each food item, each of the plurality of chess-piece-themed food items 4 may comprise a cylindrical body 7 and a chess-piece symbol 11. The cylindrical body 7 of each chess-piece-themed food item is designed to fit within the corresponding slot. The cylindrical design also allows the chess-piece-themed food item to easily be retrieved from the corresponding slot. Further, the chess-piece symbol 11 designates the type of chess piece each food item corresponds to.

Due to the cylindrical shape of the plurality of chess-piece-themed food items 4, the cylindrical body 7 comprises a lateral body wall 8, a first body base 9, and a second body base 10, as can be seen in FIGS. 7 through 10. The lateral body wall 8 corresponds to the cylindrical wall of each food item. The first body base 9 and the second body base 10 correspond to the opposite cylindrical bases of each food item. So, the first body base 9 and the second body base 10 are positioned opposite to each other about the lateral body wall 8. The overall height of the cylindrical body 7 preferably matches the depth of the corresponding slot. Further, the chess-piece symbol 11 is inscribed onto the first body base 9 to implement the chess-piece symbol 11 on the cylindrical body 7. In other embodiments, the plurality of chess-piece-themed food items 4 may have different design shapes, and the chess-piece symbol 11 may be implemented on different sides of the corresponding food item.

Like the plurality of chess-board-themed slots 13, the plurality of light-themed pieces 5 and the plurality of dark-themed pieces 6 can be distinguished from each other using different methods, as can be seen in FIGS. 7 through 10. In some embodiments, the first body base 9 for each of the plurality of light-themed pieces 5 can be a light color, while the first body base 9 for each of the plurality of dark-themed pieces 6 can be a dark color. In other words, the first body base 9 of the plurality of light-themed pieces 5 can be colored with a light color, while the first body base 9 of the plurality of dark-themed pieces 6 can be colored with a dark color.

In another embodiment, physical features can be implemented to visually indicate the theme of the plurality of chess-piece-themed food items 4. As can be seen in FIGS. 7 through 10, like the plurality of dark-themed slots 15, each of the plurality of dark-themed pieces 6 may comprise a plurality of item protruding ridges 12. The plurality of item protruding ridges 12 includes several ridges that are implemented to physically indicate the dark theme of the plurality of dark-themed pieces 6.

As can be seen in FIGS. 7 through 10, to implement the plurality of item protruding ridges 12, the plurality of item protruding ridges 12 is mounted onto the first body face. The plurality of item protruding ridges 12 is also arranged in a stripe pattern across the first body face to evenly distribute the item protruding ridges throughout the first body face of each dark-themed piece. Further, the chess-piece symbol 11 is mounted onto the first body face by the plurality of item protruding ridges 12. In other words, the chess-piece symbol 11 protrudes past the plurality of item protruding ridges 12 so that the chess-piece symbol 11 is not blocked. Furthermore, the plurality of item protruding ridges 12 is configured to visually generate the dark color by positioning the item protruding ridges close to each other. In other embodiments, different physical features can be implemented to visually indicate the dark theme of the plurality of dark-themed pieces 6.

In some embodiments, different additional features can be implemented to increase the overall functionality of the present invention. For example, the present invention can also include a protective film that is attached to the upper tray face 2 to protect the freshness of the plurality of chess-piece-themed food items 4. The depth of the plurality of chess-board-themed slots 13 is deep enough so that the chess-piece-themed food items do not come into contact with the protective film.

Further, in other embodiments, the plurality of chess-piece-themed food items 4 can be provided as a flat body with an embossing of a chess piece logo on the top of the disk. The lateral side of the chess-piece-themed food items can be a variety of different shapes including, but not limited to, a circle, a square, an oval, or any other shape that can fit into a square. In addition, the different color themes of the chess-piece-themed food items may be accomplished by individually wrapping the chess-piece-themed food items in different colored packaging. The different color themes of the chess-piece-themed food items may also be formed using different food ingredients or additives that have different colors such as white chocolate, dark chocolate, milk chocolate, candies of different flavors, etc.

In other embodiments, the plurality of chess-piece-themed food items 4 may be molded into chess pieces. High-quality molds shaped like chess pieces crafted from food-grade silicone or polycarbonate can be utilized. The process may begin by melting the food mixture to the appropriate temperature, ensuring the food mixture is smooth and free of air bubbles. This mixture may then be carefully poured into the molds, filling each cavity completely. Once filled, the molds are gently tapped to release any trapped air bubbles, which helps achieve a smooth finish on the chess pieces. The molds are then placed in a refrigerator or a cooling tunnel to allow the chocolate or candy to set and harden. After sufficient cooling, the molds are removed, and the molded chess pieces are carefully extracted, often requiring a gentle twist or tap to release the molded chess pieces without damage. The result is a detailed and precise representation of chess pieces in edible form.

In other embodiments, the plurality of chess-piece-themed food items 4 can be embossed with the corresponding chess piece. Embossing chess pieces on the chess-piece-themed food items involves creating an embossing stamp or dye with the desired chess piece designs. The stamp is typically made from metal or high-quality plastic to ensure durability and precision. To emboss the design onto the food item, the food item is first melted and poured into flat molds or sheets. Before the food item fully hardens, the embossing stamp is pressed onto a surface, imprinting the detailed design of the chess pieces. The pressure must be even and controlled to ensure a clear and consistent embossing. Once the design is imprinted, the chess-piece-themed food items are allowed to fully set and harden. The finished products feature intricate, raised designs of chess pieces.

Although the invention has been explained in relation to its preferred embodiment, it is to be understood that many other possible modifications and variations can be made without departing from the spirit and scope of the invention.

What is claimed is:

1. A chess board food serving tray comprising:
a serving tray;
a plurality of chess-piece-themed food items;
a plurality of chess-board-themed slots;
the serving tray comprising an upper tray face and a lower tray face;
the plurality of chess-board-themed slots comprising a plurality of light-themed slots and a plurality of dark-themed slots;
the plurality of chess-piece-themed food items comprising a plurality of light-themed pieces and a plurality of dark-themed pieces;
the plurality of chess-board-themed slots being integrated into the serving tray from the upper tray face;
the plurality chess-board-themed slots being arranging into a grid configuration across the upper tray face;
the plurality of dark-themed slots and the plurality of light-themed slots being interspersed amongst each other in a checkerboard pattern; and
each of the plurality of chess-piece-themed food items being positioned within a corresponding themed slot from the plurality of chess-board-themed slots.

2. The chess board food serving tray as claimed in claim 1 further comprising:
each of the plurality of chess-board-themed slots comprising a slot base;
the slot base for each of the plurality of light-themed slots being a light color; and
the slot base for each of the plurality of dark-themed slots being a dark color.

3. The chess board food serving tray as claimed in claim 2 further comprising:
each of the plurality of dark-themed slots comprising a plurality of slot protruding ridges;
the plurality of slot protruding ridges being mounted onto the slot base;
the plurality of slot protruding ridges being arranged in a stripe pattern across the slot base; and
the plurality of slot protruding ridges being configured to visually generate the dark color.

4. The chess board food serving tray as claimed in claim 1 further comprising:
each of the plurality of chess-board-themed slots comprising a slot base, a plurality of lateral walls, and a plurality of finger-receiving cutouts;
the plurality of lateral walls being positioned around the slot base; and
each of the plurality of finger-receiving cutouts being integrated into a corresponding lateral wall from the plurality of lateral walls, offset from the slot base.

5. The chess board food serving tray as claimed in claim 1 further comprising:
each of the plurality of chess-piece-themed food items comprising a cylindrical body and a chess-piece symbol;
the cylindrical body comprising a lateral body wall, a first body base, and a second body base;
the first body base and the second body base being positioned opposite to each other about the lateral body wall; and
the chess-piece symbol being inscribed onto the first body base.

6. The chess board food serving tray as claimed in claim 5 further comprising:
the first body base for each of the plurality of light-themed pieces being a light color; and
the first body base for each of the plurality of dark-themed pieces being a dark color.

7. The chess board food serving tray as claimed in claim 6 further comprising:
each of the plurality of dark-themed pieces comprising a plurality of item protruding ridges;
the plurality of item protruding ridges being mounted onto the first body face;
the plurality of item protruding ridges being arranged in a stripe pattern across the first body face;
the chess-piece symbol being mounted onto the first body face by the plurality of item protruding ridges; and
the plurality of item protruding ridges being configured to visually generate the dark color.

8. A chess board food serving tray comprising:
a serving tray;
a plurality of chess-piece-themed food items;
a plurality of chess-board-themed slots;
the serving tray comprising an upper tray face and a lower tray face;
the plurality of chess-board-themed slots comprising a plurality of light-themed slots and a plurality of dark-themed slots;
the plurality of chess-piece-themed food items comprising a plurality of light-themed pieces and a plurality of dark-themed pieces;
each of the plurality of chess-piece-themed food items comprising a cylindrical body and a chess-piece symbol;
the cylindrical body comprising a lateral body wall, a first body base, and a second body base;
the plurality of chess-board-themed slots being integrated into the serving tray from the upper tray face;
the plurality chess-board-themed slots being arranging into a grid configuration across the upper tray face;
the plurality of dark-themed slots and the plurality of light-themed slots being interspersed amongst each other in a checkerboard pattern;
each of the plurality of chess-piece-themed food items being positioned within a corresponding themed slot from the plurality of chess-board-themed slots;
the first body base and the second body base being positioned opposite to each other about the lateral body wall; and
the chess-piece symbol being inscribed onto the first body base.

9. The chess board food serving tray as claimed in claim 8 further comprising:
each of the plurality of chess-board-themed slots comprising a slot base;
the slot base for each of the plurality of light-themed slots being a light color; and
the slot base for each of the plurality of dark-themed slots being a dark color.

10. The chess board food serving tray as claimed in claim 9 further comprising:
each of the plurality of dark-themed slots comprising a plurality of slot protruding ridges;
the plurality of slot protruding ridges being mounted onto the slot base;
the plurality of slot protruding ridges being arranged in a stripe pattern across the slot base; and
the plurality of slot protruding ridges being configured to visually generate the dark color.

11. The chess board food serving tray as claimed in claim 8 further comprising:
each of the plurality of chess-board-themed slots comprising a slot base, a plurality of lateral walls, and a plurality of finger-receiving cutouts;
the plurality of lateral walls being positioned around the slot base; and
each of the plurality of finger-receiving cutouts being integrated into a corresponding lateral wall from the plurality of lateral walls, offset from the slot base.

12. The chess board food serving tray as claimed in claim 8 further comprising:
the first body base for each of the plurality of light-themed pieces being a light color; and
the first body base for each of the plurality of dark-themed pieces being a dark color.

13. The chess board food serving tray as claimed in claim 12 further comprising:
each of the plurality of dark-themed pieces comprising a plurality of item protruding ridges;
the plurality of item protruding ridges being mounted onto the first body face;
the plurality of item protruding ridges being arranged in a stripe pattern across the first body face;
the chess-piece symbol being mounted onto the first body face by the plurality of item protruding ridges; and
the plurality of item protruding ridges being configured to visually generate the dark color.

14. A chess board food serving tray comprising:
a serving tray;
a plurality of chess-piece-themed food items;
a plurality of chess-board-themed slots;
the serving tray comprising an upper tray face and a lower tray face;
the plurality of chess-board-themed slots comprising a plurality of light-themed slots and a plurality of dark-themed slots;
the plurality of chess-piece-themed food items comprising a plurality of light-themed pieces and a plurality of dark-themed pieces;
each of the plurality of chess-piece-themed food items comprising a cylindrical body and a chess-piece symbol;
the cylindrical body comprising a lateral body wall, a first body base, and a second body base;
the plurality of chess-board-themed slots being integrated into the serving tray from the upper tray face;
the plurality chess-board-themed slots being arranging into a grid configuration across the upper tray face;
the plurality of dark-themed slots and the plurality of light-themed slots being interspersed amongst each other in a checkerboard pattern;
each of the plurality of chess-piece-themed food items being positioned within a corresponding themed slot from the plurality of chess-board-themed slots;
the first body base and the second body base being positioned opposite to each other about the lateral body wall; and
the chess-piece symbol being inscribed onto the first body base.

15. The chess board food serving tray as claimed in claim 14 further comprising:
each of the plurality of chess-board-themed slots comprising a slot base;
each of the plurality of dark-themed slots comprising a plurality of slot protruding ridges;
the slot base for each of the plurality of light-themed slots being a light color;
the slot base for each of the plurality of dark-themed slots being a dark color;
the plurality of slot protruding ridges being mounted onto the slot base;
the plurality of slot protruding ridges being arranged in a stripe pattern across the slot base; and
the plurality of slot protruding ridges being configured to visually generate the dark color.

16. The chess board food serving tray as claimed in claim 14 further comprising:
each of the plurality of chess-board-themed slots comprising a slot base, a plurality of lateral walls, and a plurality of finger-receiving cutouts;
the plurality of lateral walls being positioned around the slot base; and
each of the plurality of finger-receiving cutouts being integrated into a corresponding lateral wall from the plurality of lateral walls, offset from the slot base.

17. The chess board food serving tray as claimed in claim 14 further comprising:
each of the plurality of dark-themed pieces comprising a plurality of item protruding ridges;
the first body base for each of the plurality of light-themed pieces being a light color;
the first body base for each of the plurality of dark-themed pieces being a dark color;
the plurality of item protruding ridges being mounted onto the first body face;
the plurality of item protruding ridges being arranged in a stripe pattern across the first body face;
the chess-piece symbol being mounted onto the first body face by the plurality of item protruding ridges; and
the plurality of item protruding ridges being configured to visually generate the dark color.
